(19) United States
(12) Patent Application Publication
(10) Pub. No.: US 2016/0346889 A1
(43) Pub. Date: Dec. 1, 2016

(54) LIQUID INJECTION DEVICE AND MOUNTING BRACKET OF LIQUID INJECTION DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: JIN-GANG GONG, Shenzhen (CN); WEI DING, Shenzhen (CN); JIAN-ZHOU CAO, Shenzhen (CN)

(21) Appl. No.: 15/062,453

(22) Filed: Mar. 7, 2016

(30) Foreign Application Priority Data
May 26, 2015 (CN) 201520345402.5

(51) Int. Cl. B23Q 11/10; B05B 15/06

(52) U.S. Cl. CPC B23Q 11/1084; B05B 15/061

(57) ABSTRACT

A mounting bracket of a jet assembly includes a connecting assembly and a mounting assembly. The connecting assembly includes a mounting arm, a linking arm, a mounting tab, and a rotating tab. The linking arm is rotatable relative to the mounting arm within a first plane. The mounting tab is mounted to the linking arm. The rotating tab is rotatable relative to the mounting tab within a second plane. The first plane is perpendicular to the second plane. The mounting assembly includes a securing body and a securing tab. The securing tab is mounted to the rotating tab.

### FIELD

The subject matter herein generally relates to a liquid injection device and a mounting bracket of liquid injection device.

### BACKGROUND

A manufacturing machine is a machine for shaping or machining metal or other rigid materials, usually by cutting, boring, grinding, shearing, or other forms of deformation. Cutting fluid is used in the machine tool as coolant and lubricant for metalworking processes, such as machining and stamping. A liquid injection device is needed for injecting the cutting fluid to the machine tool.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is a diagrammatic view of a liquid injection device with a mounting bracket mounted in a manufacturing machine in one embodiment.

FIG. 2 is an exploded, diagrammatic view of the liquid injection device of FIG. 1.

FIG. 3 is similar to FIG. 2, but shown from another aspect.

FIG. 4 is a cross-sectional view of a cardan of a jet assembly of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the configurations described herein. However, it will be understood by those of ordinary skill in the art that the configurations described herein can be practiced without these specific details. In other instances, methods, procedures, and components have not been described in detail so as not to obscure the related relevant feature being described. Also, the description is not to be considered as limiting the scope of the configurations described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

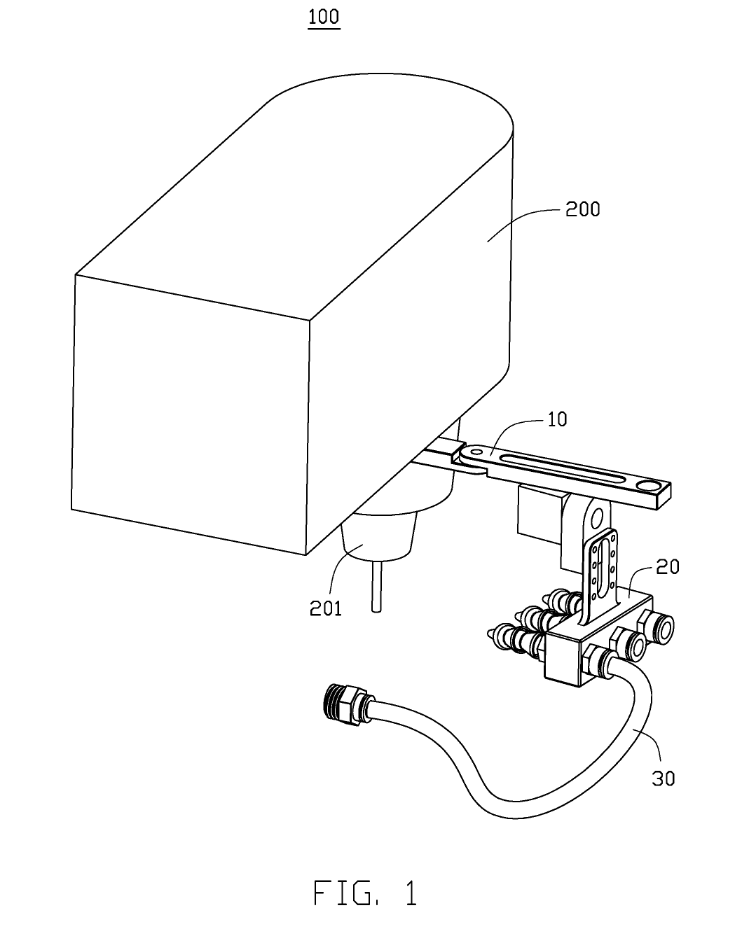

FIG. 1 illustrates a diagrammatic view of a liquid injection device and a cutting machine in at least one embodiment. A liquid injection device 100 can be mounted to a manufacturing machine 200 for injecting cutting fluid to a machine tool 201, such as cutters. The liquid injection device 100 is located adjacent to the machine tool 201.

The liquid injection device 100 includes a connecting assembly 10 connecting to the manufacturing machine 200, a mounting assembly 20 connecting to the connecting assembly 10, and a jet assembly 30 mounted to the mounting assembly 20. The jet assembly 30 can inject cutting fluid towards the machine tool 201. When the manufacturing machine 200 is on work, the position of the machine tool 201 is changed, and the injecting angle of the jet assembly 30 is adjusted accordingly through the mounting assembly 20 to follow the movement of the machine tool 201.

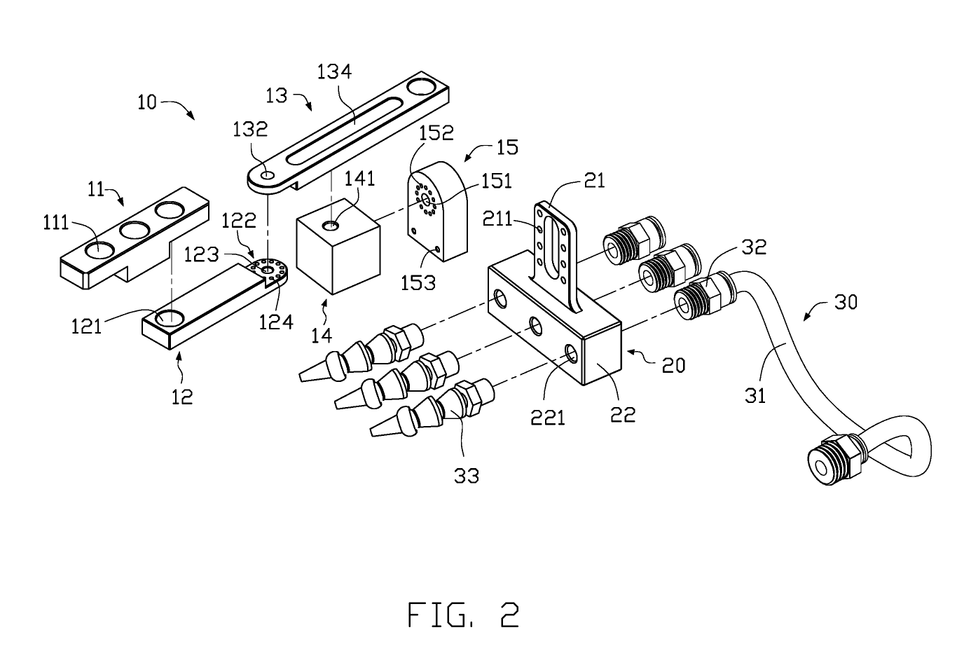

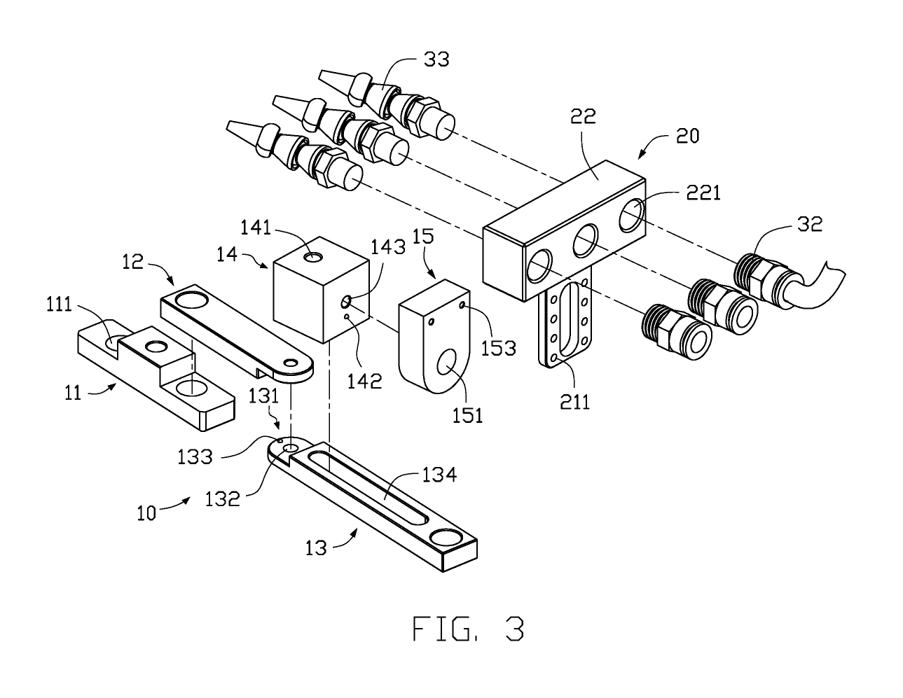

FIG. 2 illustrates an exploded view of the liquid injection device 100 in one embodiment. FIG. 3 is similar to FIG. 2, but is shown from another aspect. The connecting assembly 10 includes a base 11, a mounting arm 12, a linking arm 13, a mounting tab 14, and a rotating tab 15.

The base 11 is substantially T-shaped. A plurality of first mounting holes 111 is defined in the base 11 for mounting the mounting arm 12 to the manufacturing machine 200.

A second mounting hole 121 is defined in the mounting arm 12 at one end portion. The base 11 and the mounting arm 12 can be fixed through screws or rivets extending through the second mounting hole 121 coupling to one of plurality of first mounting hole 111. An opposite end of the mounting arm 12 defines a first recess portion 122. A circumferential flange of the first recess portion 122 is rounded. A third mounting hole 123 is defined in a central portion of the first recess portion 122. A plurality of first retaining holes 124 is defined in the first recess portion 122 and is arrayed around the third mounting hole 123.

One end portion of the linking arm 13 defines a second recess portion 131 coupling to the first recess portion 122. A circumferential flange of the second recess portion 131 is rounded. A forth mounting hole 132 is defined in a central portion of the second recess portion 131. The mounting arm 12 and the linking arm 13 can be fixed through screws or rivets extending through the third mounting hole 123 and the forth mounting hole 132. A first pin 133 protrudes adjacent to the forth mounting hole 132 and can be engaged with one of the plurality of first retaining holes 124 to adjust the angle of the linking arm 13 relative to the mounting arm 12. The horizontal angle of the linking arm 13 can be adjusted. The first pin 133 can be elastic. A slot 134 is defined in the linking arm 13 along a longitudinal direction for mounting the mounting tab 14.

The mounting tab 14 is substantially cubic. A first securing hole 141 is defined in a top surface of the mounting tab 14. A second pin 142 protrudes from a sidewall of the mounting tab 14. A second securing hole 143 is defined adjacent to the second pin 142. The mounting tab 14 and the linking arm 13 can be fixed through screws or rivets extending through the first securing hole 141 and the slot 134. A mounting position of the mounting tab 14 relative to the linking arm 13 can be adjusted along the slot 134.

An outer flange of the rotating tab 15 is rounded. A fifth mounting hole 151 and a plurality of second retaining hole 152 are defined in the rotating tab 15. The plurality of second retaining holes 152 is arrayed around the fifth mounting hole 151. The rotating tab 15 and mounting tab 14 can be fixed through screws or rivets extending through the fifth mounting hole 151 and the second securing hole 143. The second pin 142 can be engaged with one of plurality of second retaining holes 152 to retain the rotating tab 15 relative to the mounting tab 14. Thus, the rotating tab 15 can be adjusted at different angle relative to the mounting tab 14. The second pin 142 can be elastic. A pair of sixth mounting holes 153 are defined in the rotating tab 15 for mounting the mounting assembly 20.

The mounting assembly 20 includes a securing body 22 and a securing tab 21 located on the securing body 22. The securing tab 21 defines a plurality of pairs of seventh mounting holes 211. The plurality of pairs of seventh mounting holes 211 are aligned such that a column/row of one the pair is parallel to another column. The pair of sixth mounting holes 153 can be selectively coupled to one of pairs of seventh mounting holes 211 to mount the mounting assembly 20 to the rotating tab 15 to adjust vertical height of the rotating tab 15. A plurality of through holes 221 are defined in the securing body 22 to receive the jet assembly 30.

The jet assembly 30 includes three pipes 31, a connector 32 located on one end of each pipe 31, and a cardan 33 detachably fixing to each connector 32. Each pipe 31 can be a flexible plastic hose. Each connector 32 can include a thread portion at one side to fix to each through hole 221. Each connector 32 can connect to the cutting fluid at the other side. The connector 32 can also be integrated to the securing body 22 in other embodiments. Each cardan 33 is connected to each through hole 221 of the securing body 22 at opposite side of each connector 32. The cutting fluid from the jet assembly 30 can flow to the cardan 33 through the through hole 221.

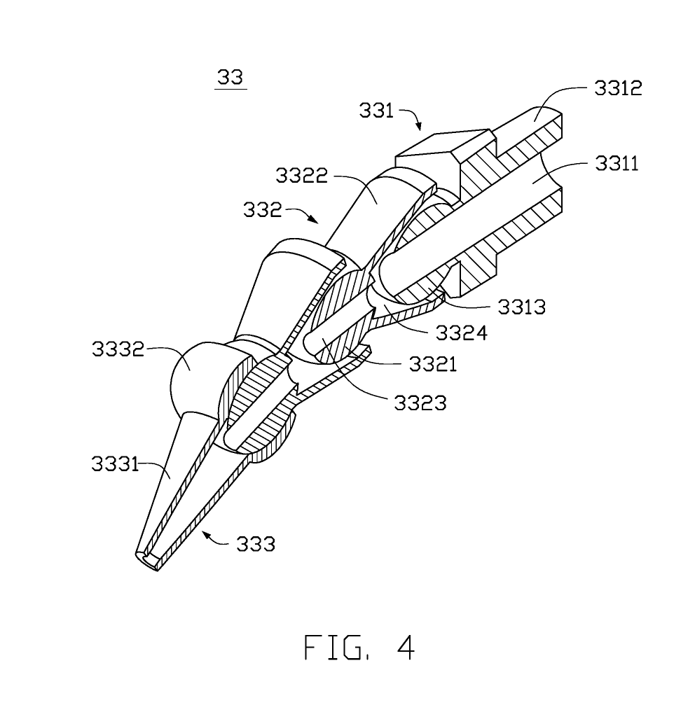

FIG. 4 illustrates a diagrammatic view of one of cardans 33 in one embodiment. Each cardan 33 includes a cardan base 331, two cardan joints 332, and a cardan jet 333. A first channel 3311 is defined in the cardan base 331. The cardan base 331 includes a base connector 3312 and a base head 3313. The base connector 3312 can be fixed to the through hole 221. The base head 3313 is substantially spherical. Each cardan joint 332 includes a joint head 3321 and a joint holder 3322. The configuration of each joint head 3321 is similar to each base head 3313, and defines a second channel 3323. Each joint holder 3322 defines a cavity 3324 to receive the base head 3313. The number of the cardan joint 332 can be one or more. The cardan jet 333 includes a nozzle 3331 and a jet holder 3332. The nozzle 3331 can be substantially conical. The configuration of the jet holder 3332 is similar to each joint holder 3322 to receive each joint head 3321.

In use, the jet assembly 30 is mounted to the mounting assembly 20. The injection direction of the jet assembly 30 can be adjusted through linking arm 13 in a horizontal position and can be adjusted through rotating tab 15 in a vertical position.

In another embodiment, a mounting bracket of liquid injection device can include a connecting assembly 10 and a mounting assembly 20 for mounting and adjusting the jet assembly 30.

The configurations shown and described above are only examples. Many details are often found in the art such as the other features of a liquid injection device and mounting bracket of liquid injection device. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the configurations described above may be modified within the scope of the claims.

What is claimed is:

1. A liquid injection device of cutting fluid comprising:
a connecting assembly comprising:
a mounting arm,
a linking arm being rotatable relative to the mounting arm within a first plane,
a mounting tab mounted to the linking arm, and
a rotating tab being rotatable relative to the mounting tab within a second plane, and the first plane being perpendicular to the second plane;
a mounting assembly comprising a securing body and a securing tab mounted to the rotating tab; and
a jet assembly comprising:
a pipe, and
a cardan connecting to the pipe being mounted to the securing body.

2. The liquid injection device of claim 1, wherein an end portion of the mounting arm defines a first recess portion, and a circumferential flange of the first recess portion is rounded; an end portion of the linking arm defines a second recess portion coupling to the first recess portion, and a circumferential flange of the second recess portion is rounded.

3. The liquid injection device of claim 2, wherein a third mounting hole is defined in a central portion of the first recess portion, a plurality of first retaining hole is defined in the first recess portion and is arrayed around the third mounting hole; a first pin protrudes from the linking arm and can be engaged with one of the plurality of first retaining holes to adjust an angle of the linking arm relative to the mounting arm.

4. The liquid injection device of claim 3, wherein the first pin is substantially elastic.

5. The liquid injection device of claim 1, wherein a slot is defined in the linking arm along a longitudinal direction for mounting the mounting tab, and a first securing hole is defined in a top surface of the mounting tab to couple to the slot.

6. The liquid injection device of claim 1, wherein a second pin protrudes from a sidewall of the mounting tab, a second securing hole is defined in the mounting tab adjacent to the second pin, a fifth mounting hole is defined in the rotating tab corresponding to the second securing hole, and a plurality of second retaining holes is defined in the rotating tab and is arrayed around the fifth mounting hole, the second pin is configured to be engaged with one of plurality of second retaining hole to retain the rotating tab relative to the mounting tab.

7. The liquid injection device of claim 6, wherein the second pin is substantially elastic.

8. The liquid injection device of claim 1, wherein a pair of sixth mounting holes are defined in the rotating tab, and the securing tab defines a plurality of pairs of seventh mounting holes, the plurality of pairs of seventh mounting holes is parallel aligned, the pair of sixth mounting holes can be selectively coupled to one of pairs of seventh mounting holes to mount the mounting assembly to the rotating tab to adjust height of the rotating tab in the second plane.

9. The liquid injection device of claim 1, wherein the cardan comprises a cardan base, a cardan joint, and a cardan jet, and the cardan joint is rotatably engaged with the cardan joint, and the cardan base is rotatably engaged with the cardan joint.

10. The liquid injection device of claim 9, wherein the cardan base defines a first channel and comprises a base head and a base connector, the base head is substantially spherical, and the base connector is mounted to the securing body ; the cardan joint comprises a joint head and a joint holder, the joint head is substantially spherical, a joint holder defines a cavity for receiving the base head, the joint head defines a second channel communicating to the first channel, the cardan jet comprises a nozzle and a jet holder, the nozzle is hollowed and the jet holder is similar to the joint holder for receiving the joint head.

11. A mounting bracket of a jet assembly, comprising:
a connecting assembly, comprising a mounting arm, a linking arm, a mounting tab, and a rotating tab, the linking arm being rotatable relative to the mounting arm within a first plane, the mounting tab being mounted to the linking arm, the rotating tab being rotatable relative to the mounting tab within a second plane, and the first plane being perpendicular to the second plane; and
a mounting assembly, comprising a securing body and a securing tab, and the securing tab mounted to the rotating tab..

12. The mounting bracket of claim 11, wherein an end portion of the mounting arm defines a first recess portion, and a circumferential flange of the first recess portion is rounded; an end portion of the linking arm defines a second recess portion coupling to the first recess portion, and a circumferential flange of the second recess portion is rounded.

13. The mounting bracket of claim 12, wherein a third mounting hole is defined in a central portion of the first recess portion, a plurality of first retaining holes is defined in the first recess portion and is arrayed around the third mounting hole ; a first pin protrudes from the first pin and can be engaged with one of the plurality of first retaining holes to adjust an angle of the linking arm relative to the mounting arm.

14. The mounting bracket of claim 13, wherein the first pin is substantially elastic.

15. The mounting bracket of claim 11, wherein a slot is defined in the linking arm along a longitudinal direction for mounting the mounting tab, and a first securing hole is defined in a top surface of the mounting tab to couple to the slot.

16. The mounting bracket of claim 11, wherein a second pin protrudes from a sidewall of the mounting tab, a second securing hole is defined in the mounting tab adjacent to the second pin, a fifth mounting hole is defined in the rotating tab corresponding to the second securing hole, and a plurality of second retaining holes are defined in the rotating tab and is arrayed around the fifth mounting hole the second pin is configured to be engaged with one of plurality of second retaining holes to retain the rotating tab relative to the mounting tab.

17. The mounting bracket of claim 16, wherein the second pin is substantially elastic.

18. The mounting bracket of claim 11, wherein a pair of sixth mounting hole are defined in the rotating tab, and the securing tab defines a plurality of pairs of seventh mounting holes, the plurality of pairs of seventh mounting holes is parallel aligned, the pair of sixth mounting holes can be selectively coupled to one of pairs of seventh mounting holes to mount the mounting assembly to the rotating tab to adjust height of the rotating tab in the second plane.
